(19) United States
(12) Patent Application Publication
(10) Pub. No.: US 2023/0016123 A1
(43) Pub. Date: Jan. 19, 2023

(54) METHODS AND SYSTEMS FOR TRAVEL TIME ESTIMATION

(71) Applicant: Motional AD LLC, Boston, MA (US)

(72) Inventor: Ashwin ARUNMOZHI, Monroeville, PA (US)

(21) Appl. No.: 17/375,019

(22) Filed: Jul. 14, 2021

(51) Int. Cl. G01C 21/34; G06N 3/04

(52) U.S. Cl. CPC G01C 21/3484; G01C 21/3492; G06N 3/04; G05D 1/0297

(57) ABSTRACT

Provided are methods for travel time estimations, which can include obtaining a profile. In one or more embodiments, the profile comprises a driving profile. The methods can include determining a travel time parameter for each of a plurality of edges in a road network based on the driving profile. The methods can include determining a travel time estimate to reach a location in the road network based on the travel time parameter. The methods can include outputting the travel time estimate. Systems and computer program products are also provided.

### BACKGROUND

Individuals can receive recommendations on a route from an origin to a destination. Such recommendation can include an estimated time of arrival or a travel time estimate to the destination. For example, the route and the travel time estimate can be generated using real time traffic data. The route and the travel time estimate can be based on a random sampling of the road speed population to estimate an average speed for every section of a road network. However, estimates of time of arrival or travel time estimates lack in accuracy which leads to imprecise estimates and difficulties in planning.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of an example planning system according to this disclosure;

FIGS. 5A-5D are diagrams of an implementation of a process for travel time estimation; and

FIG. 6 is a flowchart of a process for travel time estimation.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise. The terms “include” and “comprise” may be used interchangeably.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include and/or implement instructions and/operations including obtaining a profile. In one or more embodiments, the profile comprises a driving profile. In some aspects and/or embodiments, systems, methods, and computer program products described herein include and/or implement instructions and/operations including determining a travel time parameter for each of a plurality of edges in a road network based on the driving profile. In some aspects and/or embodiments, systems, methods, and computer program products described herein include and/or implement instructions and/operations including determining a travel time estimate to reach a location in the road network based on the travel time parameter. In some aspects and/or embodiments, systems, methods, and computer program products described herein include and/or implement instructions and/operations including outputting the travel time estimate.

By virtue of the implementation of systems, methods, and computer program products described herein, include techniques for travel time estimation. Some of the advantages of these techniques include improved accuracy of travel time estimations by accounting for a user's or vehicle's variations in driving profile or driving pattern. Specifically, the disclosed technique permits improving the real-time road speed data distribution estimates. The systems, methods, and computer program products disclosed herein provide more accurate and improved tailored shortest routes considering the driver-specific driving behavior (such as risk tolerance, impatience, and/or other factors). The disclosed technique allows for improved time-to-destination estimates. Further, by virtue of the implementation of certain techniques described herein, autonomous vehicles (AVs) can benefit from improved time-to-destination estimates determined based on the AV driving behavior.

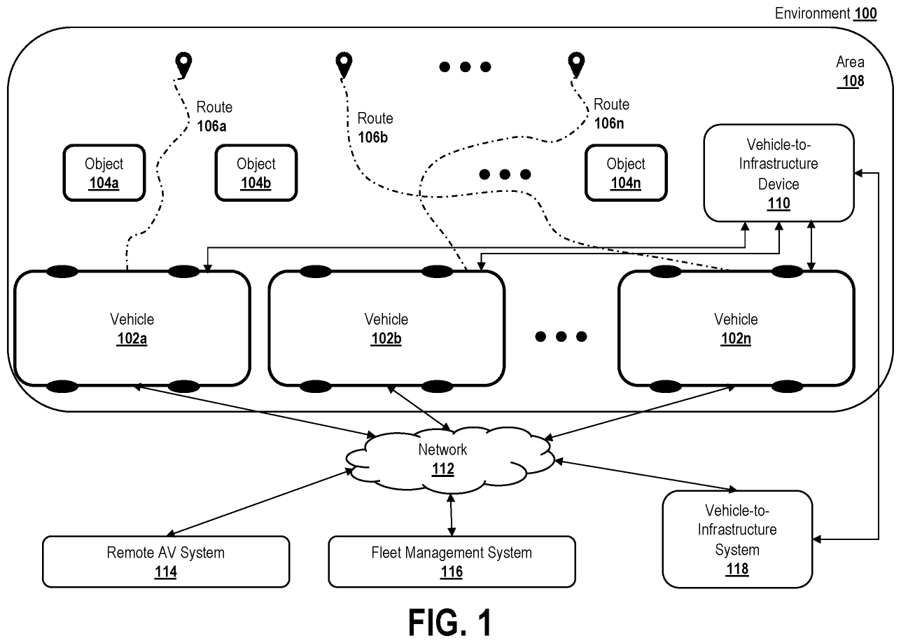

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

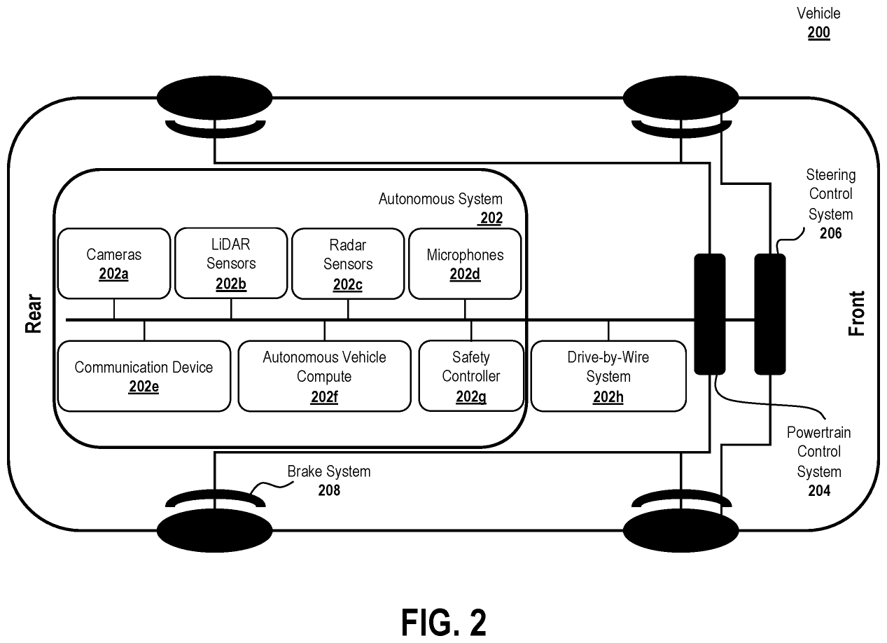

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g., a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high-level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high-level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

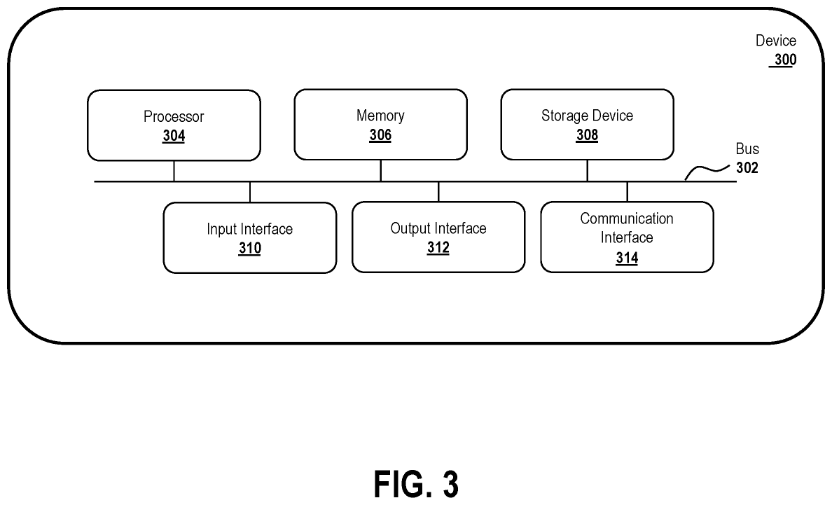

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

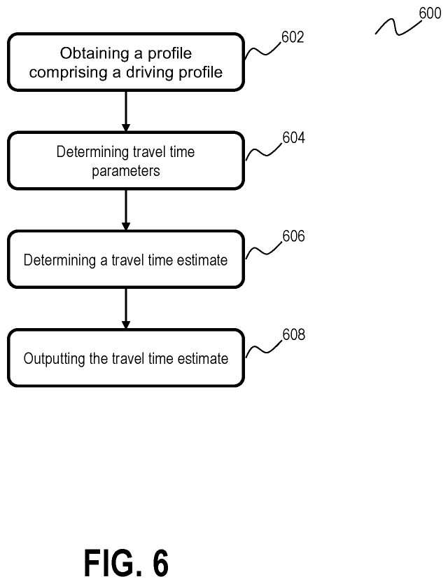

The system 202, e.g., autonomous system 202 comprises at least one processor, and at least one memory storing instructions thereon that, when executed by the at least one processor, cause the at least one processor to perform any of the methods disclosed in FIG. 6. The autonomous vehicle compute 202f may serve as the at least one processor.

The instructions, when executed by the at least one processor, cause the at least one processor to obtain a profile comprising a driving profile. In other words, the system 202 is configured to obtain, by the at least one processor, a profile comprising a driving profile. A profile can be seen as a vehicle profile (such as an AV profile), such as a profile that represents driving conditions and/or a driving behavior, such as a speed behavior of a vehicle, such as of an AV. A driving profile can be seen as a vehicle driving profile, such as an AV driving profile. AV driving profile can be seen as an AV operating profile. The driving profile can comprise one or a plurality of model parameters or parameter coefficients representing driving conditions and/or driving behavior. For example, the profile can be associated with a vehicle, such as an AV. For example, the driving profile can be associated with a vehicle, such as an AV. For example, a vehicle can have a profile in which their driving behavior (e.g., driving speed) relative to other vehicles is obtained over time to get a percentile representative of the driving behavior (e.g., an overall speed percentile) and possibly any changes in the percentile based on other road factors (e.g., time of day, weather, congestion etc.). The driving profile can take into account the time of the driving, such as time of day, day of the week, current month.

The instructions, when executed by the at least one processor, cause the at least one processor to determine a travel time parameter for each of a plurality of edges in a road network based on the driving profile. For example, the system 202 is configured to determine, by the at least one processor, a travel time parameter for each of a plurality of edges in a road network based on the driving profile.

The instructions, when executed by the at least one processor, cause the at least one processor to determine a travel time estimate to reach a location in the road network based on the travel time parameter. For example, the system 200 is configured to determine, by the at least one processor, a travel time estimate to reach a location in the road network based on the travel time parameter.

The instructions, when executed by the at least one processor, cause the at least one processor to output the travel time estimate. For example, the system 200 is configured to output, by the at least one processor, the travel time estimate, e.g., to a planning system.

In one or more example systems, the instructions that cause the at least one processor to output the travel time estimate cause the at least one processor to transmit the travel time estimate to a navigation system. The navigation system can be part of the autonomous system 202. The autonomous system 202 can also use the disclose profile to control operation of the autonomous vehicle, via the AV compute 202f.

The navigation system can be part of a fleet management system where AVs are managed, and controlled to navigate to one or more locations, e.g., in an optimized manner by exploiting the profile disclosed here. For example, an AV's travel time (such as time to pick up) may be estimated based on the disclosed travel time estimate to improve quality of service or provide enhanced optimization (e.g., to provide a coordinated drop off and/or pick up and/or stop, such as in a ride-sharing service). For example, an AV's travel time (such as time to pick up) may be estimated based on the disclosed travel time estimate for a group sharing service with different passengers needing different pick up and drop off points. An accurate travel estimation can be provided with the disclosed technique in cases of regular ride sharing usage by a user (for example, the same user requesting a ride at the same time of the day every day).

In one or more example systems, the instructions that cause the at least one processor to obtain a profile cause the at least one processor to obtain an edge profile. In other words, the profile comprises an edge profile.

In one or more example systems, the instructions that cause the at least one processor to determine the travel time parameter cause the at least one processor to obtain the travel time parameter based on the edge profile.

In one or more example systems, the edge profile comprises a speed distribution.

In one or more example systems, the instructions that cause the at least one processor to determine the travel time parameter cause the at least one processor to determine, the travel time parameter based on the speed distribution.

In one or more example systems, each travel time parameter is indicative of a speed associated with a respective edge of the plurality of edges.

In one or more example systems, each travel time parameter is indicative of a travel time associated with a respective edge of the plurality of edges.

In one or more example systems, the driving profile comprises one or more model parameters indicative of a driving behavior, the one or more model parameters including a first model parameter.

In one or more example systems, the instructions that cause the at least one processor to determine the travel time parameter cause the at least one processor to determine the travel time parameter for each of the plurality of edges based on the first model parameter.

In one or more example systems, the one or more model parameters are based on a parametric model.

In one or more example systems, the parametric model comprises a neural network.

In one or more example systems, the instructions that cause the at least one processor to determine the travel time parameter for each of a plurality of edges in a road network cause the at least one processor to determine a percentile based on the one or more model parameters.

In one or more example systems, the instructions that cause the at least one processor to determine the travel time parameter for each of a plurality of edges in a road network cause the at least one processor to determine the travel time parameter for each of the plurality of edges in the road network based on the percentile.

In one or more example systems, the instructions that cause the at least one processor to determine the travel time parameter for each of a plurality of edges in a road network based on the percentile cause the at least one processor to map the percentile onto the edge profile.

In one or more example systems, a model parameter of the one or more model parameters is representative of an accident risk.

In one or more example systems, a model parameter of the one or more model parameters is representative of congestion.

In one or more example systems, a model parameter of the one or more model parameters is representative of an order of interaction.

In one or more example systems, a model parameter of the one or more model parameters is representative of user routine.

In one or more example systems, a model parameter of the one or more model parameters is based on music data.

In one or more example systems, a model parameter of the one or more model parameters is based on age data.

In one or more example systems, the instructions that cause the at least one processor to determine the travel time estimate to reach the location in the road network based on the travel time parameter cause the at least one processor to determine a shortest path to the location.

In one or more example systems, the instructions that cause the at least one processor to output the travel time estimate cause the at least one processor to transmit the travel time estimate to a navigation system.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of remote AV system 114, fleet management system 116, V2I system 118, and/or one or more devices of network 112 (e.g., one or more devices of a system of network 112, such as a server device). In some embodiments, one or more devices of vehicles 102 (e.g., one or more devices of a system of vehicles 102), at least one device of remote AV system 114, fleet management system 116, and V2I system 118, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally, or alternatively, a set of components (e.g., one or more components) of device 300 can perform one or more functions described as being performed by another component or another set of components of device 300.

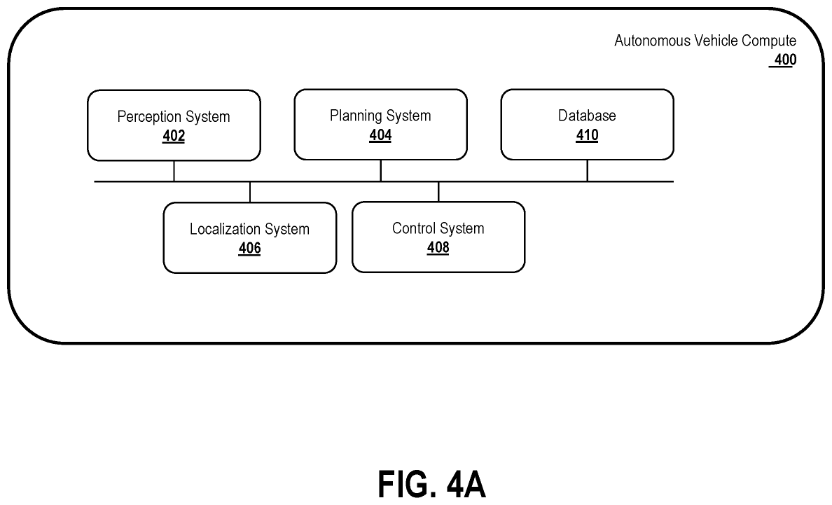

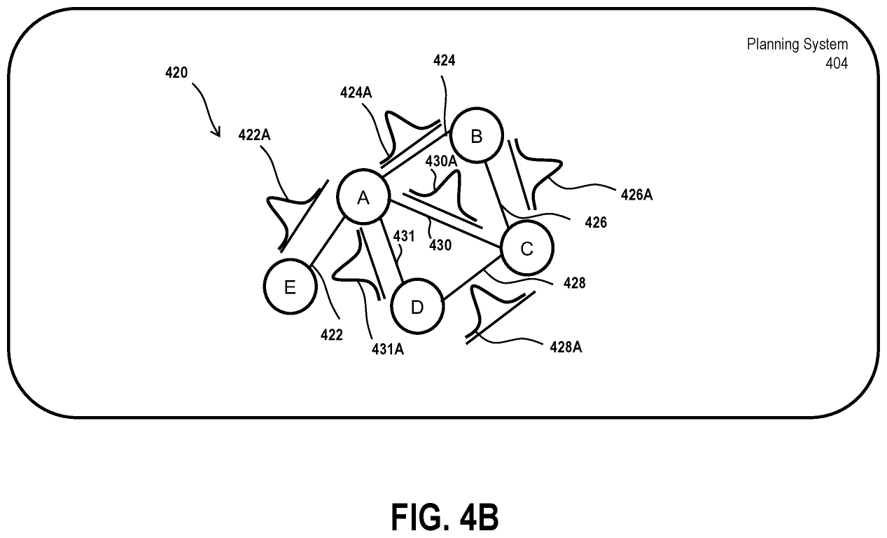

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, and/or a V2I system (e.g., a V2I system that is the same as or similar to V2I system 118 of FIG. 1) and/or the like.

FIG. 4B shows a planning system 404 (such as a planning system of a vehicle) configured to operate based on a graph 420 used in path planning. The planning system 404 can be configured to perform any of the steps of method 600 of FIG. 6. In general, a graph 420 can be used to determine a path between any start point and end point. In real-world terms, the distance separating the start point and end point can be relatively large (e.g., in two different metropolitan areas) or can be relatively small (e.g., two intersections abutting a city block or two lanes of a multi-lane road). The graph 420 can be a directed graph. A directed graph having high granularity can also be a subgraph of another directed graph having a larger scale. For example, a directed graph in which the start point B and end point D are far away (e.g., many miles apart) can have most of its information at a low granularity and is based on stored data, but can also include some high granularity information for the portion of the graph that represents physical locations in the field of view of the AV 100.

The graph 420 includes nodes A, B, C, D, E representing respective locations between a start point and an end point that could be occupied by an AV 100. The nodes are connected by edges 422, 424, 426, 428, 430, 431. For example, when two nodes E and A are connected by an edge 422, it is possible for an AV 100 to travel between one node E and the other node A, e.g., without having to travel to an intermediate node before arriving at the other node A. In other words, when reference is made to an AV 100 traveling between nodes, it is meant that the AV 100 can travel between the two physical positions represented by the respective nodes. The edges can be bidirectional, in the sense that an AV 100 can travel from a first node to a second node, or from the second node to the first node. In one or more examples, the edges can be unidirectional, in the sense that an AV 100 can travel from a first node to a second node, but cannot travel from the second node to the first node. Edges can be unidirectional when the edges represent, for example, one-way streets, individual lanes of a street, road, or highway, or other features that can only be traversed in one direction due to legal or physical constraints.

In some examples, e.g., when the start point B and end point D represent different metropolitan areas, the nodes can represent segments of roads. In some examples, e.g., when the start point B and end point D represent different locations on the same road, the nodes can represent different positions on that road. In this way, the graph 420 can include information at varying levels of granularity and/or in various dimensions.

In use, the planning system 404 can use the directed graph 420 to identify a path made up of nodes and edges between the start point B and end point D. An edge 422-431 can respectively have an associated edge profile 422A-431A. Edges 422, 424, 426, 428, 430, 431 (referred to individually as edge 422, 424, 426, 428, 430, 431 and collectively as edges 440), can each be associated with an edge profile. An edge profile can be related to a travel time parameter. For example, the edge profile can comprise a distribution for a travel time parameter, such as a speed distribution and/or a travel time distribution and/or the like. When the planning system 404 identifies a path between the start point B and end point D, the planning system 404 chooses a path optimized for travel time, e.g., the path that takes the least travel time to destination. The planning system 404 can calculate the shortest route from B to end point D, such as destination. The shortest route to destination can be computed by taking the road speed network illustrated by graph 420 where each edge profile 422A-431A represents a distribution of a travel time parameter, such as speed or travel time. The disclosed technique allows computing a travel time parameter for each edge or at least a subset of edges in the road network based on edge profiles/edge distributions and associated user-specific percentile for respective edges in the road network. In other words, a user/vehicle-dependent percentile for respective edges can be determined/obtained and subsequently mapped onto or applied to e.g., a speed or travel time distribution of the edge profile. For example, a first travel time parameter TTP_1 for a first edge E_1 in the road network can be determined based on a first percentile P_1 and a first edge profile EP_1 including a speed distribution and/or travel time distribution TTD_1 associated with the first edge E_1, such as travel time distribution 422A associated with edge 422 shown in FIG. 4B. Further, a second travel time parameter TTP_2 for a second edge E_2 in the road network can be determined based on a second percentile P_2 and a second edge profile EP_2 including a speed and/or travel time distribution TTD_2 associated with the second edge E_2, such as travel time distribution 424A associated with edge 424 shown in FIG. 4B.

More generally and assuming N edges in the road network, a travel time parameter TTP_n for the n'th edge can be determined, e.g., for n=1, . . . , N, or n being a subset of 1, 2, . . . , N. In other words, a travel time parameter TTP_n for each of a plurality of edges E_n, such as a subset of or all edges of the road network is determined.

Thus, a user/vehicle-specific percentile for a travel time parameter, such as speed or travel time, can be determined for and applied onto a distribution, such as a speed distribution or a time travel distribution, for each of a plurality of edges in the road network. The percentiles for respective edges can then be mapped to or applied onto edge-dependent travel time distributions to provide a travel time parameter for each of a plurality of edges.

For example, a specific driver or user can always drive at a higher speed on the highway (e.g., corresponding to a 0.75 percentile) but follows the speed limit on side roads (e.g., corresponding to a 0.4 percentile). A graph network with discrete edge weights (one or more travel time parameters) corresponding to edge-specific percentiles mapped onto the respective travel time distributions for edges of the graph network can be produced by the planning system. In other words, every weight or travel time parameter of the graph network can be different due to the differences in the percentile road speeds or travel time of the user and/or of the vehicle. For example, edge 422 also denoted first edge E_1 can have a (first) travel time parameter TTP_1 (such as, edge weight) of 7 and can be directed from E to A. For example, edge 424 also denoted second edge E_2 can have a (second) travel time parameter TTP_2 (such as, edge weight) of 10 and can be directed from B to A. For example, edge 426 can have a (third) travel time parameter TTP_3 (edge weight) of 20 and can be directed from C to B. For example, edge 428 can have a (fourth) travel time parameter TTP_4 (such as, edge weight) of 32 and can be directed from C to D. For example, edge 430 can have a (fifth) travel time parameter TTP_5 (such as, edge weight) of 12 and can be directed from A to C. For example, edge 431 can have a (sixth) travel time parameter TTP_6 (such as, edge weight) of 60 and can be directed from A to D. The planning system can then compute the shortest route using the Dijkstra method and/or related algorithm for finding the shortest path between nodes in a graph based on the travel time parameters/weights of the edges in the graph. For example, the shortest path from B to D can be via edges 424, 430 and 428, e.g., B-A-C-D. The planning system can compute the travel time estimate based on the travel time parameters/edge weights of edges forming the shortest path and, in case the time travel parameters is speed, also the corresponding edge length to determine the travel time estimate, such as time to arrival. For example, each travel time parameter TTP_n for the n'th edge, and thereby each calculation is specific to the user and/or to the vehicle. For example, the respective edge lengths of the edges forming the shortest path are divided by their corresponding edge weights (such as corresponding speeds for the edge) edges and summed up to obtain the travel time estimate, such as time to arrival. For example, the time travel/edge weights of the shortest path edges can be summed to obtain the travel time estimate, such as time to arrival.

In one or more embodiments, two or more redundant planning systems 404 can be included in a vehicle (e.g., a vehicle that is the same as or similar to vehicles 102, vehicle 200, an autonomous vehicle, and/or the like).

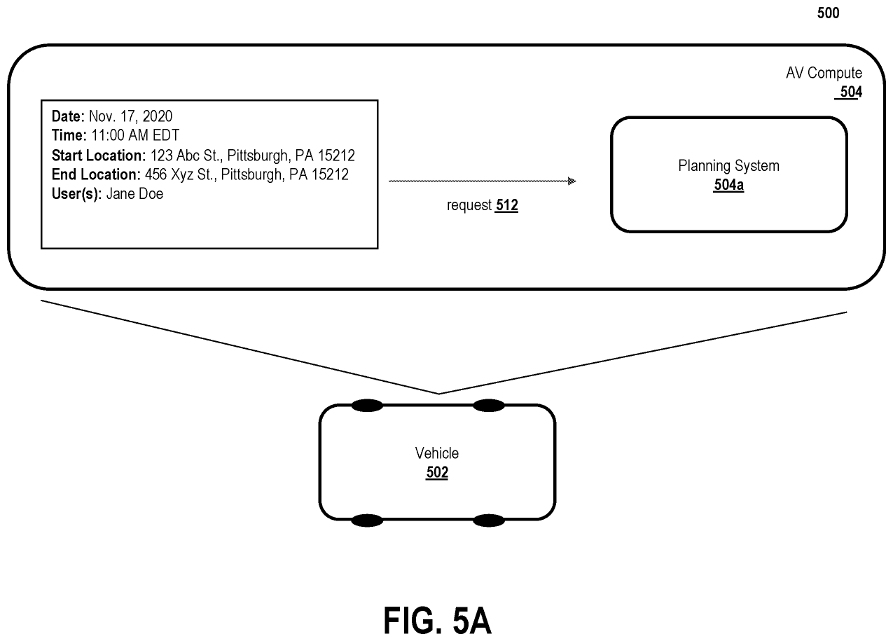

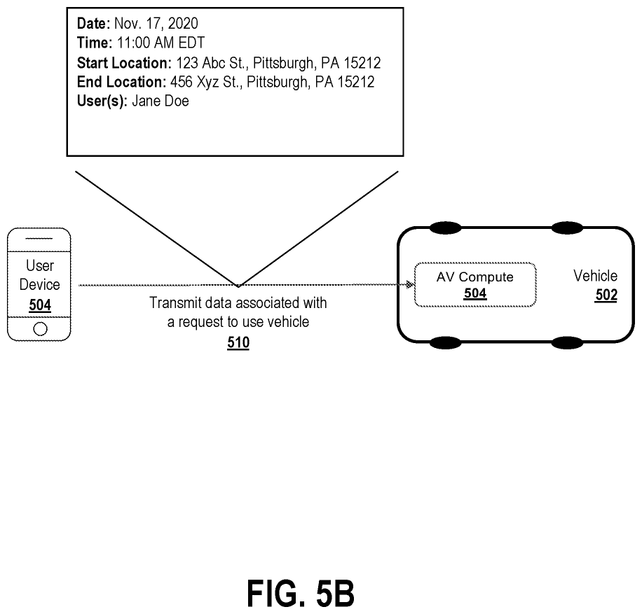

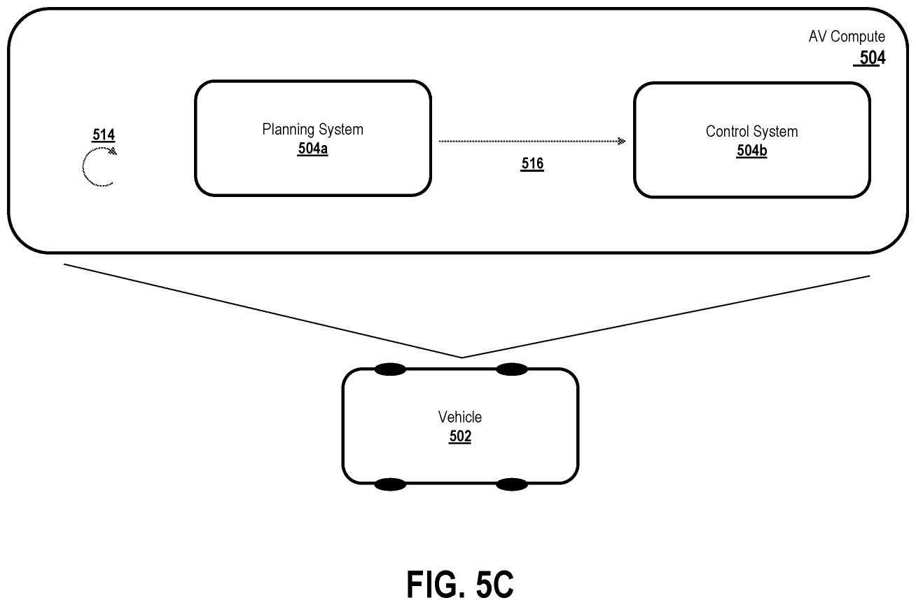

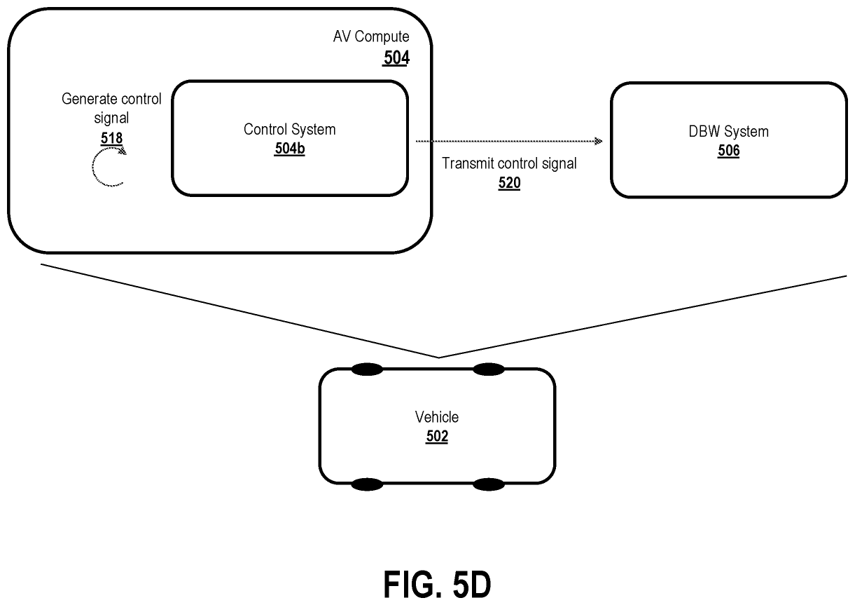

Referring now to FIGS. 5A-5D, illustrated are diagrams of an implementation 500 of a process for travel time estimation. In some embodiments, implementation 500 includes an AV compute 504, and a vehicle 502 (similar to vehicle 200 of FIG. 2), a planning system 504a. In some embodiments, system 500 is the same as or like system, such as a remote AV system, a fleet management system, a V2I system.

In FIG. 5A, vehicle 502 includes an AV compute 504. The AV compute 504 can include a planning system 504a. At step 512, the planning system 504a can obtain and/or receive a request for a travel of the vehicle 502 from a start location to an end location. The request can include information regarding the user, date information and time information. For example, the request can be generated via a user interface of the vehicle 502, e.g., a user interface of a navigation system of the vehicle 502. For example, the request can come in from a passenger while the ride is in progress when the passenger wishes to change the drop off location and the planning system 504a needs an update to support the request. Upon receiving and/or obtaining the request, the planning system 504a can be configured to perform the method disclosed herein, as illustrated in FIG. 6 and accompanying text.

In FIG. 5B, vehicle 502 includes an AV compute 504. The AV compute 504 can include a planning system. At step 510, the AV compute 504 receives a request for a travel of the vehicle 502 from a start location to an end location. The request can include information regarding the user, date information and time information. The request can be generated by a user device 504, such as a mobile phone. Upon receiving and/or obtaining the request″, the AV compute 504 can be configured to perform the method disclosed herein, as illustrated in FIG. 6 and accompanying text.

In FIG. 5C, vehicle 502 includes an AV compute 504. The AV compute 504 can include a planning system 504a and a control system 504b. The AV compute 504 can determine, at step 514, using the planning system 504a, a route and its associated travel time estimate according to methods of FIG. 6. The planning system 504a can transmit, at step 516, information indicative of the route to the control system 504b for instructing the AV compute to operate the vehicle 502 for navigation according to the route.

In FIG. 5D, vehicle 502 includes the AV compute 504 and DBW system 506. At step 518, The AV compute 504 can generate, using the control system 504b, a control signal based on the route and can transmit control signal, at step 520, to the DBW system 506 for navigating the vehicle 502 according to the control signal.

Referring now to FIG. 6, illustrated is a flowchart of a process 600 for travel time estimation. In some embodiments, one or more of the steps described with respect to process 600 are performed (e.g., completely, partially, and/or the like) by autonomous system 202. Additionally, or alternatively, in some embodiments one or more steps described with respect to process 600 are performed (e.g., completely, partially, and/or the like) by another device or group of devices separate from or including autonomous system 202.

FIG. 6. shows a flow diagram of an example method 600, performed by a system according to the disclosure, e.g., for travel time estimation. The method can be performed by a system disclosed herein, such as an AV compute 504, and a vehicle 102, 200, 502, 300 of FIGS. 1, 2, 3, 4A-B, 5A-C. The system disclosed can include at least one processor which can be configured to carry out one or more of the operations of method 600.

The method 600 includes obtaining, at step 602, by at least one processor (e.g., a process of the disclosed system), a profile comprising a driving profile. For example, a profile can be received, and/or retrieved (such as from a server device configured to maintain one or more profiles), and/or determined. A profile can be seen as a user profile and/or a vehicle profile (such as an AV profile), such as a profile that represents driving conditions and/or a driving behavior, such as a speed behavior of a user and/or of a vehicle, such as of an AV. A driving profile can be seen as a user driving profile and/or a vehicle driving profile, such as an AV driving profile. AV driving profile can be seen as an AV operating profile. The driving profile can comprise one or a plurality of model parameters or parameter coefficients representing driving conditions and/or driving behavior. For example, the profile can be associated with a user of a vehicle and/or with a vehicle, such as an AV. For example, the driving profile can be associated with a user of a vehicle and/or with a vehicle, such as an AV. For example, a user and/or a vehicle can have a profile in which their driving behavior (e.g., driving speed) relative to other users and/or other vehicles is obtained over time to get a percentile representative of the driving behavior (e.g., an overall speed percentile) and possibly any changes in the percentile based on other road factors (e.g., time of day, weather, congestion etc.). The driving profile can take into account the time of the driving, such as time of day, day of the week, current month. The driving profile can account, for example, for a regular private employee that can usually drive faster in the morning to get to the office. The driving profile can take into account individual factors, such as a mood of a driver. In one or more examples, the driver can be a driver of a driving platform and/or an autonomous vehicle. Driving data of a user and/or of a vehicle can be collected and learnt as part of the training to provide better predictions considering the various factors.

The method 600 includes determining, at step 604, by the at least one processor, a travel time parameter for each of a plurality of edges in a road network based on the driving profile. For example, travel time parameters for each of a plurality of edges in a road network can be determined based on the driving profile. In one or more examples, the travel time parameter include time, speed, and/or the like. For example, the travel time parameter include a time parameter, a speed parameter and/or the like. A road network can include a plurality of nodes corresponding to respective locations, A road network can include a plurality of edges connecting (at least partly) the nodes of the road network. The road network can be seen as a graph (as illustrated in FIG. 4B), such as a directed graph.

The method 600 includes determining, at step 606, by the at least one processor, a travel time estimate to reach a location in the road network based on the travel time parameter. In one or more examples, the travel time estimate may be determined based on the travel time parameters via the edges to reach the location. For example, the travel time estimate can be an estimated time of arrival to a location, such as a destination of a journey. In one or more examples, the travel time estimate can be determined, based on speed and/or time and/or the like, as travel time parameter(s). For example, two different users and/or vehicles travelling from the same start location to the same destination location can be provided with two different estimated time to arrival based on their individual driving profile (such as speed profile and optionally driving data with respect to certain highways and road conditions). The same can apply to two different autonomous vehicles.

The method 600 includes outputting, at step 608, by the at least one processor, the travel time estimate. In one or more examples, the step 608 of outputting the travel time estimate includes displaying a user interface element according to the travel time estimate on a display (e.g., by displaying a user interface object representative of the travel time estimate). In one or more examples, the step 608 of outputting the travel time estimate includes selecting a shortest route to the location based on the travel time estimate. In one or more examples, the step 608 of outputting the travel time estimate includes enabling an AV and/or an AV fleet to select a route using the shortest route based on an improved travel time estimate. In one or more examples, outputting 608 the travel time estimate includes communicating, e.g., transmitting, the travel time estimate and/or a route selected using the travel time estimate. The disclosed technique can improve the travel time estimate, thereby time-to-destination estimates. The disclosed technique can be applicable to a number of possible applications, ranging from individual driving directions to autonomous vehicle optimization.

In one or more example methods, the step 602 of obtaining a profile includes obtaining an edge profile or a plurality of edge profiles. In one or more example methods, the profile obtained in step 602 can include an edge profile associated with an edge of the plurality of edges or an edge profile associated with each respective edge of the plurality of edges. An edge profile can be seen as a distribution profile associated with an edge of the plurality of edges representative of the road network. An edge profile can be related to a travel time parameter. For example, the edge profile can comprise a distribution for a travel time parameter, such as a speed distribution or a travel time distribution for a given edge of the road network. Examples of edge profiles are illustrated in FIG. 4B, see 422A, 424A, 426A, 428A, 430A, 431A. In one or more example methods, the step 604 of determining, by the at least one processor, the travel time parameter (e.g., for each edge of the plurality of edges) comprise determining, by the at least one processor, the travel time parameter based on the edge profile (e.g., associated with the edge of the plurality of edges). For example, this allows providing more accurate travel time estimates even for a driver and/or a vehicle (such as an AV) that is travelling to a new location on a new stretch of road never driven before via the use of edge profile and/or driving profile, e.g., by studying or learning from similar road stretches and/or highways which the driver and/or the vehicle has travelled on before.

In one or more example methods, the edge profile includes a speed distribution. In one or more example methods, the step 604 of determining, by the at least one processor, the travel time parameter include determining, by the at least one processor, the travel time parameter based on the speed distribution. In other words, the speed and/or the time for travelling across an edge can be determined based on the speed distribution for the corresponding edge. For example, speed distributions of one or more edges of the road network can be determined (e.g., estimated) based on the current vehicle speed and/or prior knowledge of a user's historical speed percentile, and/or parameter(s) indicative of road condition(s) and/or parameter(s) indicative of other driver(s) and/or road interaction(s). It can be appreciated that the disclosed technique can improve estimation of real time road speed data distribution. Also, the disclosed technique enables an improved tailored shortest route considering driving behavior specific to a driver and/or a vehicle, such as an AV.

In one or more example methods, each travel time parameter is indicative of a speed associated with a respective edge of the plurality of edges. The speed can be seen as a velocity of a vehicle for travelling a given edge of the road network. In other words, the travel time parameter for a given edge can be indicative of the speed associated with the given edge for a given user and/or a given vehicle. In one or more examples, the speed associated with an edge for a user and/or a vehicle can be determined based on the driving profile of the corresponding user and/or the corresponding vehicle.

In one or more example methods, each travel time parameter is indicative of a travel time associated with a respective edge of the plurality of edges. The travel time can be seen as a time to travel across the edge, such as from the start point of the edge to the end point of the edge. In other words, the travel time parameter for a given edge can be indicative of the travel time associated with the given edge for a given user and/or a given vehicle. In one or more examples, the travel time associated with an edge for a user and/or a vehicle can be determined based on the driving profile of the corresponding user and/or the corresponding vehicle.

In one or more example methods, the driving profile includes one or more model parameters indicative of a driving behavior. In one or more example methods, the one or more model parameters including a first model parameter. A model parameter can refer to a parameter of a model configured to characterize a driving behavior. In one or more examples, the one or more model parameters can include a second model parameter, and optionally a third model parameter, and optionally a fourth model parameter. In one or more example methods, determining, by the at least one processor, the travel time parameter includes determining, by the at least one processor, the travel time parameter for each of the plurality of edges based on the first model parameter and/or the second model parameter. In one or more example methods, determining, by the at least one processor, the travel time parameter includes determining, by the at least one processor, the travel time parameter for each of the plurality of edges based on the third model parameter and/or the fourth model parameter. A model parameter can characterize one or more factors, such as: age, mood, accident risk, congestion, and weather. For example, the model parameter(s) can be based on sample road speeds from multiple users over time to determine average speed percentile of many users tracked. The edge profile can comprise edge parameters such as road type, length parameter indicative of a length of a corresponding edge and/or speed parameters and/or the like.

In one or more example methods, the one or more model parameters are based on a parametric model. For example, a parametric model can be generated by a stepwise analysis of available parameters. The model parameters can be in form of parameter coefficients of the parametric model. Optionally, interactions can be used where outliers can be thrown out if desired, such by Random sample consensus (RANSAC) and/or least square regression model to find the parameter coefficients, and/or another similar method.

In one or more example methods, the parametric model includes a neural network. For example, a neural network can be configured to characterize a driving behavior, e.g., across an edge. In one or more examples, the neural network can take as input, input data indicative of one or more of: a current time, a current day, a current month, a weather, a speed limit, and a congestion. For example, the neural network can be trained on historical driving data, such as of the user and/or vehicle. For example, driving data can be collected and stored over a period of time. For example, the driving data can be used to train the neural network configured to predict navigation paths and to provide or suggest more accurate travel time estimates. A continuously learning neural network can be used to predict the driving pattern and to update and/or refresh a base driving data periodically (such as hourly, daily, weekly, monthly).

In one or more example methods, determining a travel time parameter for each of a plurality of edges in a road network includes determining a percentile based on the one or more model parameters, such as a percentile P_n for each of the plurality of edges based on the one or more model parameters. For example, the percentiles P_n, n=1, 2, . . . , N can be determined based on applying the one or more model parameters of the driving profile. For example, the parametric model can be used to determine a percentile for a user for each edge or a plurality of edges of the road network. The percentile(s) can be given as:

P_n=f(time, day, month, weather, speed limit, congestion). In other words, percentile(s) can be determined as a function of one or more of time, day, month, weather, speed limit, and congestion.

For example, the percentile can be determined based on applying the one or more model parameters of the driving profile. For example, the parametric model can be used to determine a percentile for a user for an edge of the road network, such as:

percentile=A_1*time+A_2*day+A_3*month+A_4*weather+A_5*speed_limit+A_6*congestion+K-order interactions+square_terms+B (1)

where A_i, i=1-6 are parameter coefficients (such as model parameters), time, day and month denote current time, current day, current month respectively, weather denotes current weather,
speed_limit denotes speed limit for the edge,
congestion denotes a congestion parameter, such as a congestion factor, for the edge, K-order interactions denote interaction(s) on the edge (such as lane change),
square terms denote constants for a squared fitting, and
B is the intercept (such as, 50th percentile or median).
For an individual driver, some of the model parameters or their interactions may not have been measured yet. For an individual driver or vehicle, some of the parameters or their interactions may have been measured but may not have been observed to be statistically significant. For example, for an individual driver or vehicle, a prediction of the percentile can be determined based on statistical analysis and fitted via least squares regression (and/or some other method), e.g., based on the following equation:

percentile=0.3*day+4.2*weather+3.7*speed_limit−2.3*congestion+40 (2)

where a confidence interval from the model fit and a prediction confidence interval can be determined to provide a given prediction with some value of confidence so that the confidence can be improved towards a target value (such as 95% confidence interval range). Additionally, model fit metrics (e.g., Rsquare, Mean squared error, and/or Root mean squared error and/or other derivatives) can be determined and used to determine when to use the prediction method and when to rely on the distribution mean or median when making predictions and shortest route calculations.

In one or more example methods, determining 602 the travel time parameter for each of a plurality of edges in the road network includes determining the travel time parameter for each of the plurality of edges in the road network based on the percentile or based on a plurality of percentiles, such as based on an edge-specific percentile for each edge. For example, the percentile for an edge can be mapped on a speed distribution and/or the edge profile for each edge considered. For example, the percentile can be mapped onto a real time speed distribution of edge type or a specific edge. In one or more example methods, determining the travel time parameter for each of a plurality of edges in a road network based on the percentile includes mapping the percentile onto the edge profile. For example, the percentile can be mapped onto and/or associated with a real time speed distribution and/or travel time distribution of edge type or specific edge. The mapping can be implemented using a lookup table, and/or by applying a distribution function.

The determination of the travel time parameter for each edge can use a specific frequentist technique (e.g., without using a confidence score associated with the percentile value for a user and/or a vehicle, such as an AV). The determination of the travel time parameter for each edge can use alternative frequentist techniques. The determination of the travel time parameter for each edge can use a Bayesian technique. Data indicative of speed (e.g., speed data) can be collected, at some time intervals, for a user, e.g., from an application running on the vehicle compute and/or on a user's mobile phone. Data indicative of speed can be based on positioning data (e.g., from a Global Position System GPS) and/or vehicle data. For example, data indicative of speed can include one or more estimates of a vehicle speed and a confidence score associate with the percentile of a user (e.g., the user's predicted percentile). In one or more examples, data taken as input in the disclosed model can include data indicative of a location of a user and/or a vehicle via a mobile phone having no permission to track location based on calls and message tracking through tracing network towers (e.g., base stations) based on signal reception. For example, the mobile phone can be communicating with a network tower, when streaming songs. In other words, in one or more embodiments of this disclosure, users who do not use navigation nor allow location tracking can be covered to determine their driving profile.

The determination of the travel time parameter for each edge can be initialized with an initial estimate of the percentile or percentiles for a user. The initial estimate of the percentile can be obtained based on M road networks. The determination of the travel time parameter for each edge can be a normal distribution. In one or more examples, the determination of the travel time parameter for each edge can use a quantile function and/or other distributions and/or non-parametric distributions and/or similar method. In one or more embodiments, it is assumed that at least two samples of a population and neither is exactly the 0.5 quantile, and the distribution is mean. When some other distribution is used, the location and scale of the distribution can be calculated using a least squares, RANSAC, or other methods (such as (Maximum Likelihood Estimation SAmple and Consensus, MLESAC, Maximum A Posterior Sample Consensus, MAPSAC) to calculate the distributional properties and to perform regression of the data (e.g. speed data) to the percentile function.

In one or more example methods, determining the travel time parameter based on the speed distribution can include determining real time distributions of all edges of all road networks (e.g., in an area of interest) based on the current data (e.g., speed data) and prior information (e.g., a previous percentile, such as a past speed quantile) for the user. The neural network employed can be configured to learn from driving patterns of a user and/or of a vehicle and perform an update of its parameters with the latest data. The learning can be continuous to provide a greater database generation and improved accuracy. In one or more examples, where a regular user who regularly uses navigation service (e.g., on its mobile phone or on the vehicle system), the disclosed technique adopts a driving profile (e.g., a speed profile) over the usual regular route. For example, this can be applied when employees go to work on a regular basis from the same start location to the same destination location. In some embodiments, an AV's travel time or time to pick up can be estimated to improve quality of service or provide enhanced optimization (e.g., coordinated drop off and pick up). The disclosure can provide an improved time prediction that can be used to improve one or more optimization problems experienced by one or more vehicles on a road network. The disclosure method allows for a faster detection of a statistically significant difference between the disclosed model's predictions and the actual data to predict the onset of an unusual event (e.g., traffic accident just occurring).

In one or more example methods, a model parameter of the one or more model parameters is representative of an accident risk. For example, when certain drivers who are prone to accidents and have a bad history of driving are navigating and/or have navigated in the same route as that of a host vehicle, the model parameter representative of an accident risk can be used as an adjusting factor to incorporate that data to predict accidents. The one or more model parameters can include an accident risk parameter. The one or more model parameters can be indicative of accident data, such as data indicative of accident risk. For example, accident data can be used as part of training the neural network to learn data of the edge profile and/or driving profile (e.g., a speed profile). For example, when drivers and/or vehicles which are prone to accidents and have a bad history of driving are navigating and/or have navigated in the same route as that of a host vehicle, an adjusting factor is used to incorporate that data to consider the accident risk, e.g., to predict an accident. In other words, the disclosed model can be generated and/or built off-line and/or using an online component with real-time data and/or adjustment.

In one or more example methods, a model parameter of the one or more model parameters is representative of congestion. For example, certain edges can be more congested than others depending on the time of the day and/or the day of the week. The model parameter representative of congestion can be indicative of how a user and/or a vehicle behaves or drives in a congested edge, such as in congested traffic. The model parameter representative of congestion can be used as an adjusting factor to incorporate congestion data. The one or more model parameters can include a parameter indicative of congestion for an edge.

In one or more example methods, a model parameter of the one or more model parameters is representative of an order of interaction. For example, an order of interaction can be related to a lane change pattern. For example, a lane change pattern can be mapped to a highway through map data (e.g., high definition, HD, map data) to adjust, via a model parameter representative of the lane change pattern, travel time parameter calculations for an edge, (e.g., corresponding to a certain stretch of road). Interaction on the road can be indicative of the lane preference(s) for changing course in traffic or other interaction(s) on road. For example, the model parameter representative of the order of interaction may indicate that when nearing exits, the vehicle is to stay to the left while the rest of the time the vehicle can stay in the middle or right most lane. For example, the model parameter representative of the order of interaction may indicate aggressive lane change pattern vs. passive course changing.

In one or more example methods, a model parameter of the one or more model parameters is representative of user routine. The user routine can be indicative of e.g., going to the gym, going to work, going to a grocery store. For example, the model parameter representative of user routine can be derived based on studying to data indicative of locations visited, by a user and/or a vehicle, on a regular basis (such as going to the gym to work out or going to play a sport every week on the same day). Data indicative of user routine can be used to predict the travel time estimate to reach a destination, e.g., while driving later. It can be envisaged that the model parameter representative of user routine for a specific edge (e.g., for a specific road) can be used when sufficient data indicative of user routine is available. This can improve the accuracy of the travel time estimate disclosed herein. Path planning can combine other regular routines to avoid traffic. For example, data indicative of user routine can include and/or capture data about visiting shopping centers, like supermarkets to buy groceries on a regular weekly basis. For example, in case of heavy traffic in a certain portion of the navigation path, the planning system can provide one or more indications (e.g., suggestions) to travel to an additional stop, e.g., for finishing the shopping while the traffic due to an accident gets cleared. For example, the planning system can provide, (e.g., by calculating mileage based on previous fuel cycle to suggest possible detours) one or more indications (e.g., suggestions) for a route or a detour to fuel the vehicle while a congestion clears out.

In one or more example methods, a model parameter of the one or more model parameters is based on music data. For example, music data can be data indicative of music played in vehicle, such a via a mobile phone and/or a vehicle sound system and/or the like. Music data can be used to predict the mood of a user, e.g., driver. Music data can be used to determine and/or update accordingly the driving profile, e.g., a driving pattern.

In one or more example methods, a model parameter of the one or more model parameters is based on age data. Age data can be data indicative of age of a user and/or of a vehicle. Age data can include the age of a driver for example. Age data can be used to characterize a model parameter and to classify a driver and to determine and/or update a driving profile, e.g., to predict a driving pattern (e.g., lane changes on one or m edges, such as edges corresponding to certain frequently used highways). For example, path planning and time estimation as disclosed herein can be more efficient in reducing congestion on roads. For example, the planning system disclosed herein can provide instructions so that a slow-moving driver and a fast-moving driver can be put on different paths. For example, the planning system disclosed herein can provide instructions so that a slow-moving vehicle (such as AV) and a fast-moving vehicle (such as AV) can be put on different paths. Eventually, this can help regulate traffic and reduce possible accidents.

In one or more example methods, determining the travel time estimate to reach the location in the road network based on the travel time parameter includes determining a shortest path to the location. Determining the shortest path to the location can include computing the shortest route using Dijkstra or related algorithm for finding a shortest route or path, as illustrated in FIG. 4B.

In one or more example methods, outputting the travel time estimate includes transmitting the travel time estimate to a navigation system. For example, a navigation system is included in the vehicle configured to carry out the disclosed method, such as an AV. For example, a navigation system is external to the vehicle configured to carry out the disclosed method. For example, the disclosed technique outputting the travel time estimate can be integrated with the navigation system to assist users who use maps in navigating to a destination. For example, the navigation system can be part of a fleet management system.

In one or more example methods, outputting the travel time estimate includes transmitting the travel time estimate to a platform of shared mobility services. The disclosed techniques can allow more accurately predicting the travel time estimate (e.g., the estimated arrival time of cabs, and/or shared rides and/or the like). It is noted that the estimated time of arrival given by a shared mobility service platform are not very accurate today. This disclosure can provide more accurate estimated time of arrivals of a cab and/or a shared ride. The disclosed technique can be even more effective for cabs and/or shared rides in that cabs or shared vehicles for shared rides travel around a defined region on a regular basis and cover the same set of roads. This allows the planning system (e.g., in the vehicle, e.g., in an AV) learning better about the driving pattern and/or speed profile to determine accurately the disclosed profiles.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

Also disclosed are methods, non-transitory computer readable media, and systems according to any of the following items:

Item 1. A method comprising:
obtaining, by at least one processor, a profile comprising a driving profile;
determining, by the at least one processor, a travel time parameter for each of a plurality of edges in a road network based on the driving profile;
determining, by the at least one processor, a travel time estimate to reach a location in the road network based on the travel time parameter; and
outputting, by the at least one processor, the travel time estimate.
   Item 2. The method of item 1, wherein obtaining a profile comprises obtaining an edge profile, and wherein determining, by the at least one processor, the travel time parameter comprises determining, by the at least one processor, the travel time parameter based on the edge profile.
   Item 3. The method of item 2, wherein the edge profile comprises a speed distribution, and wherein determining, by the at least one processor, the travel time parameter comprises determining, by the at least one processor, the travel time parameter based on the speed distribution.
   Item 4. The method of any one of items 1-3, wherein each travel time parameter is indicative of a speed associated with a respective edge of the plurality of edges.
   Item 5. The method of any one of items 1-3, wherein each travel time parameter is indicative of a travel time associated with a respective edge of the plurality of edges.
   Item 6. The method of any one of items 1-5, wherein the driving profile comprises one or more model parameters indicative of a driving behavior, the one or more model parameters including a first model parameter, and wherein determining, by the at least one processor, the travel time parameter comprises determining, by the at least one processor, the travel time parameter for each of the plurality of edges based on the first model parameter.
   Item 7. The method of item 6, wherein the one or more model parameters are based on a parametric model.
   Item 8. The method of item 7, wherein the parametric model comprises a neural network.
   Item 9. The method of any one of items 6-8, wherein determining the travel time parameter for each of a plurality of edges in a road network comprises:
determining a percentile based on the one or more model parameters, and determining the travel time parameter for each of the plurality of edges in the road network based on the percentile.
   Item 10. The method of item 9 dependent on item 2, wherein determining the travel time parameter for each of a plurality of edges in a road network based on the percentile comprises mapping the percentile onto the edge profile.
   Item 11. The method of any one of items 6-10, wherein a model parameter of the one or more model parameters is representative of an accident risk.
   Item 12. The method of any one of items 6-11, wherein a model parameter of the one or more model parameters is representative of congestion.
   Item 13. The method of any one of items 6-12, wherein a model parameter of the one or more model parameters is representative of an order of interaction.
   Item 14. The method of any one of items 6-13, wherein a model parameter of the one or more model parameters is representative of user routine.
   Item 15. The method of any one of items 6-14, wherein a model parameter of the one or more model parameters is based on music data.
   Item 16. The method of any one of items 6-15, wherein a model parameter of the one or more model parameters is based on age data.
   Item 17. The method of any one of items 1-16, wherein determining the travel time estimate to reach the location in the road network based on the travel time parameter comprises determining a shortest path to the location.
   Item 18. The method of any one of items 1-17, wherein outputting the travel time estimate comprises transmitting the travel time estimate to a navigation system.
   Item 19. A non-transitory computer readable medium comprising instructions stored thereon that, when executed by at least one processor, cause the at least one processor to carry out operations comprising:
obtaining a profile comprising a driving profile;
determining a travel time parameter for each of a plurality of edges in a road network based on the driving profile;
determining a travel time estimate to reach a location in the road network based on the travel time parameter; and
outputting the travel time estimate.
   Item 20. The non-transitory computer readable medium of item 19, wherein obtaining a profile comprises obtaining an edge profile, and wherein determining the travel time parameter comprises determining, by the at least one processor, the travel time parameter based on the edge profile.
   Item 21. The non-transitory computer readable medium of item 20, wherein the edge profile comprises a speed distribution, and wherein determining the travel time parameter comprises determining, by the at least one processor, the travel time parameter based on the speed distribution.
   Item 22. The non-transitory computer readable medium of any one of items 19-21, wherein each travel time parameter is indicative of a speed associated with a respective edge of the plurality of edges.
   Item 23. The non-transitory computer readable medium of any one of items 19-21, wherein each travel time parameter is indicative of a travel time associated with a respective edge of the plurality of edges.
   Item 24. The non-transitory computer readable medium of any one of items 19-23, wherein the driving profile comprises one or more model parameters indicative of a driving behavior, the one or more model parameters including a first model parameter, and wherein determining the travel time parameter comprises determining, by the at least one processor, the travel time parameter for each of the plurality of edges based on the first model parameter.
   Item 25. The non-transitory computer readable medium of item 24, wherein the one or more model parameters are based on a parametric model.
   Item 26. The non-transitory computer readable medium of item 25, wherein the parametric model comprises a neural network.
   Item 27. The non-transitory computer readable medium of any one of items 24-26, wherein determining the travel time parameter for each of a plurality of edges in a road network comprises:
determining a percentile based on the one or more model parameters, and determining the travel time parameter for each of the plurality of edges in the road network based on the percentile.
   Item 28. The non-transitory computer readable medium of item 27 dependent on claim 20, wherein determining the travel time parameter for each of a plurality of edges in a road network based on the percentile comprises mapping the percentile onto the edge profile.
   Item 29. The non-transitory computer readable medium of any one of items 24-28, wherein a model parameter of the one or more model parameters is representative of an accident risk.
   Item 30. The non-transitory computer readable medium of any one of items 24-29, wherein a model parameter of the one or more model parameters is representative of congestion.
   Item 31. The non-transitory computer readable medium of any one of items 24-30, wherein a model parameter of the one or more model parameters is representative of an order of interaction.
   Item 32. The non-transitory computer readable medium of any one of items 24-31, wherein a model parameter of the one or more model parameters is representative of user routine.
   Item 33. The non-transitory computer readable medium of any one of items 24-32, wherein a model parameter of the one or more model parameters is based on music data.
   Item 34. The non-transitory computer readable medium of any one of items 24-33, wherein a model parameter of the one or more model parameters is based on age data.
   Item 35. The non-transitory computer readable medium of any one of item 19-34, wherein determining the travel time estimate to reach the location in the road network based on the travel time parameter comprises determining a shortest path to the location.
   Item 36. The non-transitory computer readable medium of any one of claims items 19-35, wherein outputting the travel time estimate comprises transmitting the travel time estimate to a navigation system.
   Item 37. A system, comprising at least one processor; and at least one memory storing instructions thereon that, when executed by the at least one processor, cause the at least one processor to:
obtain a profile comprising a driving profile;
determine a travel time parameter for each of a plurality of edges in a road network based on the driving profile;
determine a travel time estimate to reach a location in the road network based on the travel time parameter; and
output the travel time estimate
   Item 38. The system of item 37, wherein the instructions that cause the at least one processor to obtain a profile cause the at least one processor to obtain an edge profile and wherein the instructions that cause the at least one processor to determine the travel time parameter cause the at least one processor to determine the travel time parameter based on the edge profile.
   Item 39. The system of item 38, wherein the edge profile comprises a speed distribution, and wherein the instructions that cause the at least one processor to determine the travel time parameter cause the at least one processor to determine the travel time parameter based on the speed distribution.
   Item 40. The system of any one of items 37-39, wherein each travel time parameter is indicative of a speed associated with a respective edge of the plurality of edges.
   Item 41. The system of any one of items 37-39, wherein each travel time parameter is indicative of a travel time associated with a respective edge of the plurality of edges.
   Item 42. The system of any one of items 37-41, wherein the driving profile comprises one or more model parameters indicative of a driving behavior, the one or more model parameters including a first model parameter, and wherein the instructions that cause the at least one processor to determine the travel time parameter cause the at least one processor to determine the travel time parameter for each of the plurality of edges based on the first model parameter.
   Item 43. The system of item 42, wherein the one or more model parameters are based on a parametric model.
   Item 44. The system of item 43, wherein the parametric model comprises a neural network.
   Item 45. The system of any one of items 42-44, wherein the instructions that cause the at least one processor to determine a travel time parameter for each of a plurality of edges in a road network cause the at least one processor to:
determine a percentile based on the one or more model parameters, and
determine the travel time parameter for each of the plurality of edges in the road network based on the percentile.
   Item 46. The system of item 45 dependent on item 38, wherein the instructions that cause the at least one processor to determine the travel time parameter for each of a plurality of edges in a road network based on the percentile cause the at least one processor to map the percentile onto the edge profile.
   Item 47. The system of any one of items 42-46, wherein a model parameter of the one or more model parameters is representative of an accident risk.
   Item 48. The system of any one of items 42-47, wherein a model parameter of the one or more model parameters is representative of congestion.
   Item 49. The system of any one of items 42-48, wherein a model parameter of the one or more model parameters is representative of an order of interaction.
   Item 50. The system of any one of items 42-49, wherein a model parameter of the one or more model parameters is representative of user routine.
   Item 51. The system of any one of items 42-50, wherein a model parameter of the one or more model parameters is based on music data.
   Item 52. The system of any one of items 42-51, wherein a model parameter of the one or more model parameters is based on age data.
   Item 53. The system of any one of items 37-52, wherein the instructions that cause the at least one processor to determine the travel time estimate to reach the location in the road network based on the travel time parameter cause the at least one processor to determine a shortest path to the location.
   Item 54. The system of any one of items 37-53, wherein to output the travel time estimate comprises to transmit the travel time estimate to a navigation system.

1. A method comprising:
obtaining, by at least one processor, a profile comprising a driving profile;
determining, by the at least one processor, a travel time parameter for each of a plurality of edges in a road network based on the driving profile;
determining, by the at least one processor, a travel time estimate to reach a location in the road network based on the travel time parameter; and
outputting, by the at least one processor, the travel time estimate.

2. The method of claim 1, wherein obtaining a profile comprises obtaining an edge profile, and wherein determining, by the at least one processor, the travel time parameter comprises determining, by the at least one processor, the travel time parameter based on the edge profile.

3. The method of claim 2, wherein the edge profile comprises a speed distribution, and wherein determining, by the at least one processor, the travel time parameter comprises determining, by the at least one processor, the travel time parameter based on the speed distribution.

4. The method of claim 1, wherein each travel time parameter is indicative of a speed associated with a respective edge of the plurality of edges.

5. The method of claim 1, wherein each travel time parameter is indicative of a travel time associated with a respective edge of the plurality of edges.

6. The method of claim 1, wherein the driving profile comprises one or more model parameters indicative of a driving behavior, the one or more model parameters including a first model parameter, and wherein determining, by the at least one processor, the travel time parameter comprises determining, by the at least one processor, the travel time parameter for each of the plurality of edges based on the first model parameter.

7. The method of claim 6, wherein the one or more model parameters are based on a parametric model.

8. The method of claim 7, wherein the parametric model comprises a neural network.

9. The method of claim 6, wherein determining the travel time parameter for each of a plurality of edges in a road network comprises:
determining a percentile based on the one or more model parameters, and determining the travel time parameter for each of the plurality of edges in the road network based on the percentile.

10. The method of claim 9, wherein determining the travel time parameter for each of a plurality of edges in a road network based on the percentile comprises mapping the percentile onto the edge profile.

11. The method of claim 6, wherein a model parameter of the one or more model parameters is representative of an accident risk.

12. The method of claim 6, wherein a model parameter of the one or more model parameters is representative of congestion.

13. The method of claim 6, wherein a model parameter of the one or more model parameters is representative of an order of interaction.

14. The method of claim 6, wherein a model parameter of the one or more model parameters is representative of user routine.

15. The method of claim 6, wherein a model parameter of the one or more model parameters is based on music data.

16. The method of claim 6, wherein a model parameter of the one or more model parameters is based on age data.

17. The method of claim 1, wherein determining the travel time estimate to reach the location in the road network based on the travel time parameter comprises determining a shortest path to the location.

18. The method of claim 1, wherein outputting the travel time estimate comprises transmitting the travel time estimate to a navigation system.

19. A non-transitory computer readable medium comprising instructions stored thereon that, when executed by at least one processor, cause the at least one processor to carry out operations comprising:
obtaining a profile comprising a driving profile;
determining a travel time parameter for each of a plurality of edges in a road network based on the driving profile;
determining a travel time estimate to reach a location in the road network based on the travel time parameter; and
outputting the travel time estimate.

20. A system, comprising at least one processor; and at least one memory storing instructions thereon that, when executed by the at least one processor, cause the at least one processor to:
obtain a profile comprising a driving profile;
determine a travel time parameter for each of a plurality of edges in a road network based on the driving profile;
determine a travel time estimate to reach a location in the road network based on the travel time parameter; and
output the travel time estimate.
